(19) United States
(12) Patent Application Publication
(10) Pub. No.: US 2019/0374913 A1
(43) Pub. Date: Dec. 12, 2019

(54) STIRRED TANK

(71) Applicant: Institute of Process Engineering, Chinese Academy of Sciences, Beijing (CN)

(72) Inventors: Chao YANG, Beijing (CN); Qinghua ZHANG, Beijing (CN); Zaisha MAO, Beijing (CN); Xiangyang LI, Beijing (CN); Xin FENG, Beijing (CN)

(73) Assignee: Institute of Process Engineering, Chinese Academy of Sciences, Beijing (CN)

(21) Appl. No.: 16/434,272

(22) Filed: Jun. 7, 2019

(30) Foreign Application Priority Data
Jun. 12, 2018 (CN) 201810599444.X

(51) Int. Cl. B01F 7/16; B01F 7/00; B01F 7/18

(52) U.S. Cl. CPC B01F 7/1675; B01F 7/0025; B01F 7/186; B01F 7/00633

(57) ABSTRACT

The present disclosure provides a stirred tank. The stirred tank includes a tank body, a stirring shaft, a plurality of blades and baffles. The tank body is configured to hold the material to be stirred; an axis of the stirring shaft is configured to coincide with an axis of the tank body; the blades are disposed on the stirring shaft; the baffles are disposed in the tank body and arranged at a periphery of the stirring shaft, and each baffle is provided with a plurality of punched holes and has a wave-like cross section. During the agitation of the stirred tank, a large number of high-speed jets are formed after the fluid passes through the punched holes.

### CROSS-REFERENCES TO RELATED APPLICATIONS

This application claims priority to Chinese patent application No. 201810599444.X filed on Jun. 12, 2018, disclosure of which is incorporated herein by reference in its entirety.

### TECHNICAL FIELD

The present disclosure relates to stirring device techniques, and, in particular, to a stirred tank.

### BACKGROUND

The stirred tank is one of the important devices for mixture and reaction of materials in the chemical production process. The stirred tank generally comprises a tank body and a stirring shaft, blades and baffles inside the tank body. The stirring shaft is arranged on the central axis of the tank body, the blades are fixed on the stirring shaft, and the baffles are fixed on the inner wall of the tank body. In the stirred tank, the rotation of the blades produces a discharge flow. The discharge flow forms a complex flow field due to the action of the baffles and the inner wall of the tank. The flow pattern, flow velocity and flow direction of the discharge flow vary due to the interaction between the blades and the baffles. Therefore, the configuration and assemble method of the blades and the baffles are important factors influencing the performance of the stirred tank.

In the stirred tank, the function of the baffles is to change the rotational motion of the liquid into a vertical inversion motion, eliminate the vortex around the stirring shaft, increase the turbulence intensity at the wall of the stirred tank, and improve the effective utilization of the applied power. The baffles limit the tangential velocity of the liquid and increase the axial velocity of the liquid. The net effect of the baffles is to provide a wide flow area for the discharge flow and enhance mixing effect. The flow pattern formed by the appropriate number of baffles is beneficial for thorough mixing of the material in the tank; however, excessive number of baffles may reduce the flow of material in the tank and limit the mixing to localized areas, resulting in poor mixing. At present, four standard rectangular baffles each having a width of 1/12˜ 1/10 of the inner diameter of the tank are applied in most industrial stirred tanks, but when this kind of rectangular baffle is applied, a turbulent vortex appears near the baffles, resulting in a local small cycle and a dead zone formed at the rear of the baffles, thereby reducing the overall fluidity of the material.

Studies have shown that opening holes in each of the standard rectangular baffles can improve the flow of material near the baffles and the wall of the tank, and improve the stirring efficiency of the stirred tank. Therefore, the rectangular punched baffles each having circular holes and the rectangular punched baffles each having rectangular holes appear in related art. These baffles can only increase stirring efficiency of the stirred tank to a small extent.

### SUMMARY

The present disclosure provides a stirred tank to solve the problem of a limited effect on the material flow condition by the existing baffles, so as to further improve the stirring efficiency of the stirred tank.

One embodiment of the present disclosure provides a stirred tank. The stirred tank includes: a tank body, a stirring shaft, a blade and a plurality of baffles;

The tank body is configured to hold the material to be stirred;

An axis of the stirring shaft is configured to coincide with an axis of the tank body;

The blade is disposed on the stirring shaft; and

The baffles are disposed in the tank body and arranged at a periphery of the stirring shaft, and each baffle of the plurality of baffles is provided with a plurality of punched holes and has a wave-like cross section.

In one embodiment of the stirred tank, the wave-like cross section is composed of a plurality of broken lines or a plurality of arcs.

In one embodiment of the stirred tank, in a case where the wave-like cross section is composed of a plurality of broken lines, the angle of adjacent broken lines ranges from 10° to 170°, for example 20°, 30°, 40°, 50°, 60°, 70°, 80°, 90°, 100°, 110°, 120°, 130°, 140°, 150°, 160° or 165°.

In one embodiment of the stirred tank, the baffles are mounted on the inner wall of the tank body.

In one embodiment of the stirred tank, a gap is provided between the each baffle and the inner wall of the tank body.

In one embodiment of the stirred tank, a length of the wave-like cross section of the each baffle in the radial direction of the tank body is 1/15˜ 1/10 of a diameter of the tank body, for example 1/14, 1/13, 1/12 or 1/11 of the diameter of the tank body.

In one embodiment of the stirred tank, the number of the baffles is in a range of 2 to 8 and the baffles are evenly distributed along a circumferential direction of the tank body, for example the number of the baffles is 3, 4, 5, 6, or 7.

In one embodiment of the stirred tank, the each baffle is configured to be inclined forward or backward by 0° to 30° with respect to a liquid flow direction, for example an inclined angle is 3°, 5°, 10°, 12°, 16°, 20°, 22°, 25° or 28°.

In one embodiment of the stirred tank, a shape of each punched hole is a circle, a triangle or a polygon.

In one embodiment of the stirred tank, in a case where the each punched hole is a circle, a diameter of the each punched hole ranges from 2 mm to 50 mm, for example 5 mm, 10 mm, 15 mm, 18 mm, 20 mm, 25 mm, 30 mm, 35 mm, 38 mm, 40 mm, 45 mm or 48 mm.

The advantage of the present disclosure:

In the stirred tank proposed by the present disclosure, the baffles are disposed in the tank body and arranged at a periphery of the stirring shaft. Each baffle is provided with punched holes and has a wave-like cross-section. During the agitation of the stirred tank, a large number of high-speed jets are formed after the fluid passes through the punched holes. Since the cross-section of the baffle is a wave-like shape, the high-speed jets collide with each other to form impinging streams, thereby further increasing the velocity gradient of the fluid near the baffles of the stirred tank, improving the flow condition of the dead zone between the baffles and the inner wall of the tank, thus improving the mixing effect of the fluid, and the stirring efficiency of the stirred tank.

### BRIEF DESCRIPTION OF DRAWINGS

FIG. 1 is a structural diagram of a stirred tank according to Embodiment 1 of the present disclosure.

FIG. 2 is a structural diagram of a cross section of a baffle of the stirred tank in the form of a wave formed by a broken line according to an embodiment of the present disclosure.

FIG. 3 is a structural diagram of a cross section of a baffle of the stirred tank in the form of a wave formed by continuing arcs according to Embodiment 3 of the present disclosure.

FIG. 4 is a structural diagram of a cross section of a baffle of the stirred tank in the form of a wave formed by continuing semicircles according to Embodiment 3 of the present disclosure.

FIG. 5 is a structural diagram of a stirred tank according to Comparative example 1 of the present disclosure.

FIG. 6 is a structural diagram of a stirred tank according to Comparative example 2 of the present disclosure.

FIG. 7 is a structural diagram of a stirred tank according to Comparative example 3 of the present disclosure.

In the Drawings: 1, tank body; 2, stirring shaft; 3, blade; 4, baffle; 41, punched hole; 4′, standard rectangular baffle; and 41′, rectangular hole.

### DETAILED DESCRIPTION

Hereinafter the present disclosure will be further described in detail in conjunction with the drawings and embodiments.

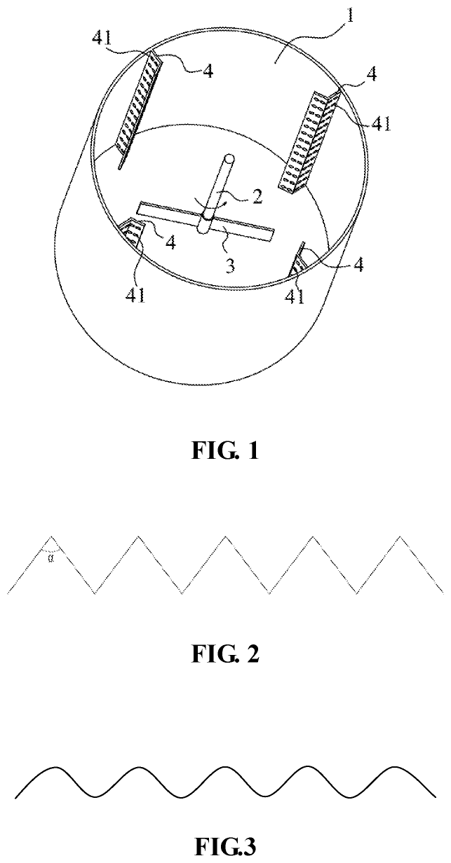

The embodiment provides a stirred tank. As shown in FIG. 1, the stirred tank comprises a tank body 1, a stirring shaft 2, a blade 3 and a plurality of baffles 4; the tank body 1 is configured to hold the material to be stirred; an axis of the stirring shaft 2 coincides with an axis of the tank body 1; the blades 3 are disposed on the stirring shaft 2; the baffles 4 are disposed in the tank body 1 and arranged on an inner wall of the tank body 1, and each baffle 4 is provided with a plurality of punched holes 41. The cross section of the baffle 4 is a wave-like shape. During the agitation of the blades 3 in the stirred tank of the present disclosure, a large number of high-speed jets are formed after the fluid passes through the punched holes 41. Since the cross-section of the baffle 4 is the wave-like shape, the high-speed jets pass through the baffles 4 and crash each other to form as impinging streams, thereby further increasing the velocity gradient of the fluid in the region of the baffles 4 in the stirred tank, improving the flow condition of the dead zone between the baffles 4 and the inner wall of the tank body 1, improving the mixing effect of the fluid, and improving stirring efficiency of the stirred tank.

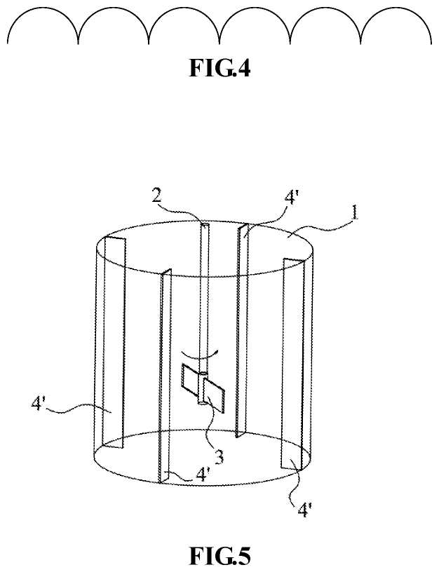

Specifically, the cross-section of the baffle 4 is the wave-like shape, as shown in FIG. 2 to FIG. 4, and the wave-like cross section is composed of a plurality of broken lines, a plurality of arcs or a plurality of semicircles. The wave-like shape can also be formed by other shapes, and can be selected according to specific conditions.

When the wave-like cross section is composed of a plurality of broken lines, an angle α between adjacent broken lines ranges from 10° to 170°. In condition that the angle between adjacent broken lines is within the angular range, the effect of forming impinging streams through the fluid passing through the punched holes 41 is optimal.

The baffles 4 are mounted on the inner wall of the tank body 1, or a gap is provided between the baffles 4 and the inner wall of the tank body 1 to improve the fluidity of the fluid.

In order to further increase the mixing extent of the fluid in the stirred tank, the relevant parameters of the baffle 4 are designed as follows: the length of the cross section of the baffle 4 in the radial direction of the tank body 1 is 1/151/10 of the diameter of the tank body 1; The number of baffles is 2 to 8 and the baffles 4 are evenly distributed along the circumferential direction of the tank body 1; the baffles 4 can be inclined forward or backward by 0° to 30° with respect to the liquid flow direction.

In order to further increase the extent of mixing of the fluid in the stirred tank, the relevant parameters of each punched hole 41 are designed as follows: the shape of the punched hole 41 is a circle, a triangle or a polygon, and preferably a circle. In a case where the punched hole 41 is a circle, the diameter of the punched hole 41 ranges from 2 mm to 50 mm.

The blade 3 may be a combination of one or more of a straight blade, a pitched blade, a ribbon blade, and other blade types.

The performance of the stirred tank provided by the present disclosure is described and demonstrated by the following embodiment and comparative examples:

### Embodiment 1

As shown in FIG. 1, in the present embodiment, the diameter of the tank body 1 of the stirred tank is 282 mm, the height of the tank body 1 is 300 mm, and the blade 3 comprises two straight blades, the diameter of sweeping range of the blade 3 is 140 mm, and the height of the blade 3 is 28 mm. The height of the blade 3 from the bottom of the tank body 1 is 93 mm. The four baffles 4 are attached to the inner wall of the tank body 1. The top view of the baffle 4 is a broken line shape (as shown in FIG. 2), the angle α between adjacent two broken lines is 90°, the total length of the baffle 4 in the radial direction of the tank body 1 is 28 mm, and the length of the baffle 4 in the longitudinal direction is 300 mm. The diameter of the punched hole 41 is 5 mm, and a center distance between adjacent two punched holes 41 is 10 mm. In the present embodiment, the stirring medium in the stirred tank is water, the liquid level is 282 mm, the temperature at the time of stirring is room temperature, the pressure is ambient pressure, and the stirring speed is 300 rpm. In the present disclosure, the mixing time (measured by electrical conductivity) is used to characterize the stirring efficiency of the stirred tank, and the shorter the mixing time is, the higher the efficiency is.

### Embodiment 2

Embodiment 2 differs from Embodiment 1 in that the diameter of the punched hole 41 is 50 mm.

### Embodiment 3

Embodiment 3 differs from Embodiment 1 in that, as shown in FIG. 3, the shape of the cross section of the baffle 4 is a wave-like shape formed by arcs.

### Embodiment 4

Embodiment 4 differs from the Embodiment 1 in that, as shown in FIG. 3, the shape of the cross section of the baffle 4 is a wave-like shape formed by semicircles.

### Embodiment 5

Embodiment 5 differs from Embodiment 1 in that the angle α between adjacent broken lines is 170°.

### Embodiment 6

Embodiment 6 differs from Embodiment 1 in that the angle α between adjacent broken lines is 10°.

### Embodiment 7

Embodiment 7 differs from Embodiment 1 in that the length of the baffle 4 in the radial direction of the tank body 1 is 24 mm.

### Embodiment 8

Embodiment 8 differs from Embodiment 1 in that the length of the baffle 4 in the radial direction of the tank body 1 is 18.67 mm.

### Embodiment 9

Embodiment 9 differs from Embodiment 1 in that the blade 3 is a push-down type pitched blade, and the angle between the blade 3 and the horizontal plane is 30°.

### Comparative Example 1

Comparative example 1 differs from Embodiment 1 in that, as shown in FIG. 5, a standard rectangular baffle 4′ is disposed inside the tank body 1, and no holes 41 are provided in the standard rectangular baffle 4′.

### Comparative Example 2

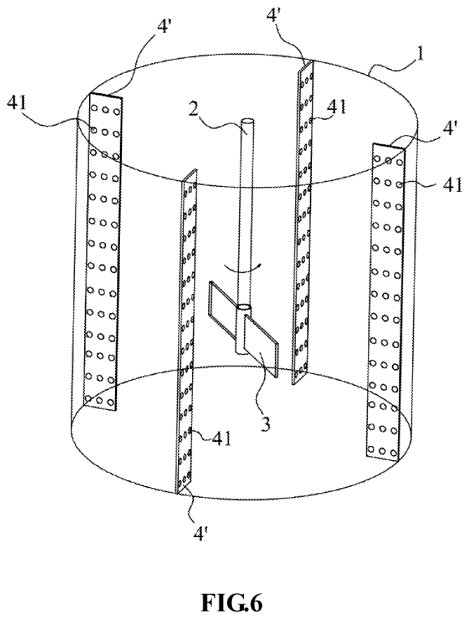

Comparative example 2 differs from Embodiment 1 in that, as shown in FIG. 6, a standard rectangular baffle 4′ is disposed inside the tank body 1, and a plurality of punched holes 41 are provided on the standard rectangular baffle 4′, each punched hole 41 is a circular hole, the diameter of the punched hole 41 is 5 mm, and the center distance between the adjacent two punched holes 41 is 10 mm.

### Comparative Example 3

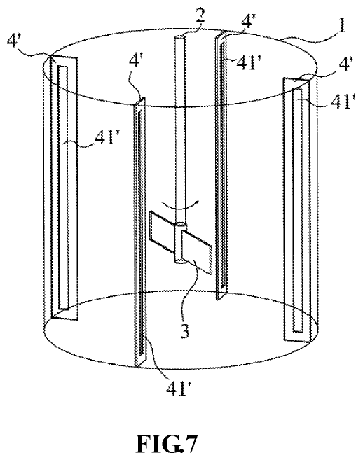

Comparative example 3 differs from Embodiment 1 in that, as shown in FIG. 7, a standard rectangular baffle 4′ is disposed inside the tank body 1, and a rectangular hole 41′ is provided on the standard rectangular baffle 4′, and the length of the rectangular hole 41′ is 260 mm, and the width of the rectangular hole 41′ is 10 mm.

### Comparative Example 4

Comparative example 4 differs from Comparative example 2 in that the diameter of the punched hole 41 is 50 mm.

### Comparative Example 5

Comparative example 5 differs from the third Comparative example 3 in that the length of the rectangular hole 41′ is 260 mm, and the width of the rectangular hole 41′ is 20 mm.

### Comparative Example 6

Comparative example 6 differs from Comparative example 1 in that the length of the standard rectangular baffle 4′ in the radial direction of the tank body 1 is 24 mm.

### Comparative Example 7

Comparative example 7 differs from Comparative example 2 in that the length of the standard rectangular baffle 4′ provided with the punched holes 41 in the radial direction of the tank body 1 is 24 mm.

### Comparative Example 8

Comparative example 8 differs from Comparative example 3 in that the length of the standard rectangular baffle 4′ provided with the rectangular holes 41′ in the radial direction of the tank body 1 is 24 mm.

### Comparative Example 9

Comparative example 9 differs from Comparative example 1 in that the length of the standard rectangular baffle 4′ in the radial direction of the tank body 1 is 18.67 mm.

### Comparative Example 10

Comparative example 10 differs from Comparative example 2 in that the length of the standard rectangular baffle 4′ provided with the punched holes 41 in the radial direction of the tank body 1 is 18.67 mm.

### Comparative Example 11

Comparative example 11 differs from Comparative example 3 in that the length of the standard rectangular baffle 4′ provided with the rectangular holes 41′ in the radial direction of the tank body 1 is 18.67 mm.

### Comparative Example 12

Comparative example 12 differs from Comparative example 1 in that the blade 3 is a push-down type pitched blade, and the angle between the blade 3 and the horizontal plane is 30°.

### Comparative Example 13

Comparative example 13 differs from Comparative example 2 in that the blade 3 is a push-down type pitched blade, and the angle between the blade 3 and the horizontal plane is 30°.

### Comparative Example 14

Comparative example 14 differs from Comparative example 3 in that the blade 3 is a push-down type pitched blade, and the angle between the blade 3 and the horizontal plane is 30°.

Table 1 shows the experimental results of the mixing times of each embodiment and each comparative example at the same stirring speed.

| | Stirring | Stirring | Mixing |
|---|---|---|---|
| | speed/rpm | power/W | time/s |
| Embodiment 1 | 300 | 18.97 | 6.23 |
| Embodiment 2 | 300 | 18.62 | 5.98 |
| Embodiment 3 | 300 | 18.72 | 6.35 |
| Embodiment 4 | 300 | 18.77 | 6.11 |
| Embodiment 5 | 300 | 18.59 | 5.5 |
| Embodiment 6 | 300 | 18.59 | 6.48 |
| Embodiment 7 | 300 | 18.79 | 6.38 |
| Embodiment 8 | 300 | 18.09 | 6.49 |
| Embodiment 9 | 300 | 16.99 | 7.08 |
| Comparative example 1 | 300 | 18.65 | 7.16 |
| Comparative example 2 | 300 | 18.67 | 7.09 |
| Comparative example 3 | 300 | 18.75 | 6.69 |
| Comparative example 4 | 300 | 18.59 | 6.94 |
| Comparative example 5 | 300 | 18.66 | 6.45 |
| Comparative example 6 | 300 | 18.72 | 7.26 |
| Comparative example 7 | 300 | 18.75 | 7.03 |
| Comparative example 8 | 300 | 18.66 | 6.75 |
| Comparative example 9 | 300 | 18.12 | 7.33 |
| Comparative example 10 | 300 | 18.05 | 7.12 |
| Comparative example 11 | 300 | 18.06 | 6.88 |
| Comparative example 12 | 300 | 16.92 | 7.95 |
| Comparative example 13 | 300 | 16.84 | 7.82 |
| Comparative example 14 | 300 | 16.89 | 7.41 |

From Table 1, it can be seen from the comparison between Embodiment 1 and each of Comparative example 1 to Comparative example 3 that the mixing time of the stirred tank of Embodiment 1 is reduced, with respect to that of Comparative example 1 to Comparative example 3, by 12.99%, 12.13% and 6.88%, respectively. Therefore, the stirred tank of the present disclosure can more effectively strengthen the mixing of the materials in the stirred tank and improve the stirring efficiency.

In Embodiment 2, compared with Comparative example 1, Comparative example 4 and Comparative example 5, the mixing time is decreased by 16.48%, 13.83% and 7.29%, respectively. When the diameter of the punched hole 41 is increased, the mixing effect of the stirred tank of the present disclosure is better, and the stirring efficiency is improved.

It can be seen from the comparison of the mixing time between Embodiment 3 and each of Comparative example 1 to Comparative example 3 that when the shape of the baffle 4 is a wave-like shape formed by arcs, the mixing time of the stirred tank of Embodiment 3 is decreased, with respect to that of Comparative example 1 to Comparative example 3, by 11.31%, 10.44%, and 5.08%, respectively.

It can be seen from the comparison between Embodiment 4 and each of Comparative example 1 to Comparative example 3 that when the shape of the baffle 4 is a wave-like shape formed by semicircles, the mixing time of the stirred tank of Embodiment 4 is decreased, with respect to that of Comparative example 1 to Comparative example 3, by 14.66%, 13.82% and 8.67%, respectively.

It can be seen from the comparison between Embodiment 4 and each of Embodiment 3 and Embodiment 1 that in a case where the shape of the baffle 4 is a wave-like shape formed by semicircles, the decreasing magnitude of mixing time of the stirred tank is greater than that of the stirred tank in related art, and the stirring efficiency is higher.

It can be seen from the comparison between Embodiment 5 and each of Comparative example 1 to Comparative example 3 that in a case where the angle α between two adjacent broken lines is 170°, the mixing time of the stirred tank of Embodiment 5 is decreased, with respect to that of Comparative example 1 to Comparative example 3, by 23.18%, 22.43% and 17.79%, respectively.

It can be seen from the comparison between Embodiment 6 and each of Comparative example 1 to Comparative example 3 that in a case where the angle α between two adjacent broken lines is 10°, the mixing time of the stirred tank of Embodiment 6 is decreased, with respect to that of Comparative example 1 to Comparative example 3, by 9.50%, 8.60% and 3.14%, respectively.

By comparing Embodiment 5, Embodiment 6 and Embodiment 1, it can be seen that in a case where the angle α between two adjacent broken lines ranges from 10° to 170°, the mixing time of the stirred tank for each of Embodiment 5, Embodiment 6 and Embodiment 1 is reduced, with respect to that of the stirred tank in related art. The decreasing magnitude of the mixing time in a case where the angle of the adjacent folding line is 170° is greater, and the stirring efficiency is higher.

It can be seen that from the comparison between Embodiment 7 and each of Comparative example 6 to Comparative example 8 that in a case where the length of the baffle 4 in the radial direction of the tank body 1 is 24 mm, the mixing time of the stirred tank of Embodiment 7 is decreased, with respect to that of Comparative example 6 to Comparative example 8, by 12.12%, 9.25% and 5.48%, respectively.

It can be seen from the comparison between Embodiment 8 and each of Comparative example 9 to Comparative example 11 that in a case where the length of the baffle 4 in the radial direction of the tank body 1 is 18.67 mm, the mixing time of the stirred tank of Embodiment 8 is decreased, with respect to that of Comparative example 9 to Comparative example 11, by 11.46%, 8.85% and 5.67%, respectively.

By comparing Embodiment 1, Embodiment 7, and Embodiment 8, it can be seen that in a case where the length of the baffle 4 in the radial direction of the tank body 1 is 1/151/10 of the diameter of the tank body 1, the mixing time of the stirred tank of the present disclosure is reduced, with respect to that of the stirred tank in related art; and in a case where the length of the baffle 4 in the radial direction of the tank body 1 is 1/10 of the diameter of the tank body 1, the decreasing magnitude of the mixing time of the stirred tank in the present disclosure is greater than that of the stirred tank in related art, and the stirring efficiency is higher.

It can be seen from the comparison between Embodiment 9 and each of Comparative example 12 to Comparative example 14, in a case where the blade 3 is a push-down type pitched blade, and the angle between the blade 3 and the horizontal plane is 30°, the mixing time of the stirred tank of Embodiment 9 is decreased, with respect to that of Comparative example 12 to Comparative example 14, by 10.94%, 9.46% and 4.45%, respectively.

It can be seen from the comparison between Embodiment 9 and Embodiment 1, the straight blades are more efficient in stirring than the pitched blades.

It is to be noted that the above embodiments are only optional embodiments of the present disclosure and the technical principles used therein. It will be understood by those skilled in the art that the present disclosure is not limited to the embodiments described herein. Those skilled in the art can make various apparent modifications, adaptations, combinations and substitutions without departing from the scope of the present disclosure. Therefore, while the present disclosure has been described in detail via the above-mentioned embodiments, the present disclosure is not limited to the above-mentioned embodiments and may include more other equivalent embodiments without departing from the concept of the present disclosure. The scope of the present disclosure is determined by the scope of the appended claims.

What is claimed is:

1. A stirred tank, comprising:
a tank body configured to hold the material to be stirred;
a stirring shaft, wherein an axis of the stirring shaft is configured to coincide with an axis of the tank body;
a blade disposed on the stirring shaft; and
a plurality of baffles, wherein the baffles are disposed in the tank body and arranged at a periphery of the stirring shaft, and each baffle of the plurality of baffles is provided with a plurality of punched holes and has a wave-like cross section.

2. The stirred tank of claim 1, wherein the wave-like cross section is composed of a plurality of broken lines or a plurality of arcs.

3. The stirred tank of claim 2, wherein in a case where the wave-like cross section is composed of a plurality of broken lines, an angle between adjacent broken lines ranges from 10° to 170°.

4. The stirred tank of claim 1, wherein the baffles are mounted on the inner wall of the tank body.

5. The stirred tank of claim 1, wherein a gap is provided between the each baffle and the inner wall of the tank body.

6. The stirred tank of claim 1, wherein a length of the wave-like cross section of the each baffle in the radial direction of the tank body is 1/15˜ 1/10 of a diameter of the tank body.

7. The stirred tank of claim 1, wherein the number of the baffles is in a range of 2 to 8 and the baffles are evenly distributed along a circumferential direction of the tank body.

8. The stirred tank of claim 1, wherein the each baffle is configured to be inclined forward or backward by 0° to 30° with respect to a liquid flow direction.

9. The stirred tank of claim 1, wherein a shape of each punched hole is a circle, a triangle or a polygon.

10. The stirred tank of claim 9, wherein in a case where the each punched hole is the circle, the diameter of the each punched hole ranges from 2 mm to 50 mm.
